(19) United States
(12) Patent Application Publication
(10) Pub. No.: US 2008/0002279 A1
(43) Pub. Date: Jan. 3, 2008

(54) Method and apparatus for writing a spiral servo pattern on a disk in a disk drive

(75) Inventors: Shinichirou Kouhara, Hino-shi (JP); Masahide Yatsu, Akishima-shi (JP); Masafumi Iwashiro, Ome-shi (JP); Hideo Sado, Ome-shi (JP); Katsuki Ueda, Ome-shi (JP); Seiji Mizukoshi, Nishitama-gun (JP); Shouji Nakajima, Kodaira-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,909

(22) Filed: Jun. 29, 2007

(30) Foreign Application Priority Data
Jun. 30, 2006 (JP) 2006-182044

(51) Int. Cl. G11B 21/02

(52) U.S. Cl. 360/75

(57) ABSTRACT

According to one embodiment, a self-servo writing method for use in disk drives, which has a first process and a second process. In the first process, a base-servo pattern containing address codes and servo-burst patterns is recorded on a disk medium in units of one-track pitches. In the second process, a drive-servo pattern, which is a spiral servo pattern, is recorded on the disk medium, by using the base-servo pattern and the self-servo writing function of the disk drive.

### CROSS-REFERENCE TO RELATED APPLICATIONS

This application is based upon and claims the benefit of priority from Japanese Patent Application No. 2006-182044, filed Jun. 30, 2006, the entire contents of which are incorporated herein by reference.

### BACKGROUND

1. Field

One embodiment of the present invention relates to a method and apparatus for writing a spiral servo pattern on a disk medium in a disk drive.

2. Description of the Related Art

In disk drives, a representative example of which is a hard disk drive, the positioning of the heads is controlled in accordance with the serve data (servo pattern) that is recorded on a disk-shaped medium (disk medium), i.e., a data-recording medium. That is, the heads are moved to target positions (i.e., target tracks or target cylinders) on the disk medium, in accordance with the servo data the heads have read.

The servo data (servo pattern) has been recorded on the disk medium in the servo-writing step performed in manufacturing the desk drive. In the ordinary servo-writing step, an apparatus called servo-track writer (STW) writes the servo data on the disk medium before or after the disks are incorporated into the disk drive.

The disk drives recently developed have an increased storage capacity. In other words, tracks are formed in higher density on a disk medium than before. It therefore takes a longer time to write servo data on a disk medium. The increase in the servo-data writing time inevitably lowers the efficiency of the manufacture of the disk drive.

In view of this, various methods have been proposed, aiming at raising the efficiency of writing the servo data. In one method, a part of the servo-burst pattern (burst signal), which is a part of the servo data, is written by a STW on a disk medium, and then the remaining part of the servo data is recorded on the disk medium, by the self-servo writing (SSW) method using said part of the servo-burst pattern. (See, for example, Japanese Patent No. 3334628). In the SSW method, the servo data is recorded by the disk drive, without using an STW.

To increase the efficiency of the servo-writing step, it is proposed that the STW be used in the SSW method, in order to shorten the time required for writing the servo data, particularly the servo-burst pattern contained in the servo data. However, the servo-data writing time cannot be adequately shortened if only a part of the servo-burst pattern is written by the SSW method.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of a disk drive according to an embodiment of the present invention;

FIG. 2 is a diagram explaining a concentric servo pattern according to the embodiment of the invention;

FIG. 3 is a diagram explaining a spiral servo pattern according to the embodiment;

FIG. 4 is a diagram explaining a process of recording the concentric base-servo pattern according to the embodiment;

FIG. 5 is a diagram explaining a process of recording the spiral servo pattern according to the embodiment;

FIG. 6 is a diagram explaining areas that can be tracked by using the concentric servo pattern according to the embodiment;

FIG. 7 is a diagram explaining areas that can be tracked by using the spiral servo pattern according to the embodiment;

FIG. 8 is a diagram explaining other areas that can be tracked by using the concentric driving servo pattern according to the embodiment;

FIG. 9 is a diagram explaining other areas that can be tracked by using the spiral servo pattern according to the embodiment;

FIGS. 10A and 10B are diagrams explaining the principle of the second process performed in the embodiment; and

FIGS. 11A to 11F are diagrams explaining the sequence of the second process performed in the embodiment.

### DETAILED DESCRIPTION

Various embodiments according to the invention will be described hereinafter with reference to the accompanying drawings. In general, according to one embodiment of the invention, a method of writing servo data on a disk medium, by the self-servo writing method, is to provide facilities to shorten the servo-data writing time and ultimately to increase the efficiency of the servo-writing step.

(Configuration of the Disk Drive)

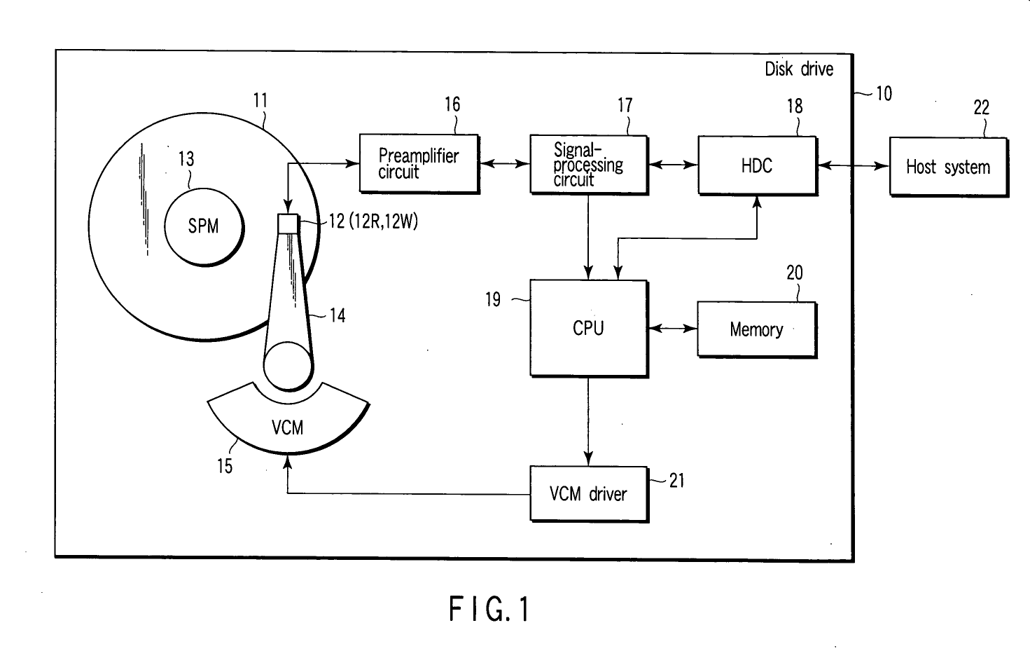

FIG. 1 is a block diagram showing the configuration of a disk drive according to this embodiment.

The method of writing servo data for use in this embodiment utilizes the function of the self-servo writing (SSW). That is, the microprocessor (CPU) 19 of a disk drive 10 writes servo data (servo pattern) on a disk-shaped medium 11 incorporated in the disk drive 10.

The disk drive 10 has a head 12 and a spindle motor (SPM) 13. The SPM 13 rotates the disk medium 11 (i.e., magnetic recording medium) at high speed. The head 12 includes a read head 12R and a write head 12W. The read head 12R reads data from the disk medium 11. The write head 12W writes data on the disk medium 11. The data contains a base-servo pattern, a drive-servo pattern and user data, as will be described later.

The head 12 is mounted on an actuator 14 that is driven by a voice coil motor (VCM) 15. The VCM 15 is supplied with a drive current from a VCM driver 21 and is driven and controlled. The actuator 14 is driven and controlled by the CPU 19 as will be described later. It is a carriage mechanism that moves the head 12 to, and positions the same, at a target position (target track) on the disk medium 11.

The disk drive 10 has a preamplifier circuit 16, a signal-processing unit 17, a disk controller (HDC) 18, a CPU 19 and a memory 20, in addition to the head-disk assembly described above.

The preamplifier circuit 16 has a read amplifier and a write amplifier. The read amplifier amplifies the read-data signal output from the read head 12R of the head 12. The write amplifier amplifies a write-data signal that is to be supplied to the write head 12W. More precisely, the write amplifier converts the write-data signal output from the signal-processing unit 17 to a write-current signal, which is supplied to the write heat 12W.

The signal-processing unit 17, which processes read signals and write signals, is also known as “read/write channel.” A read signal and a write signal contain not only a signal corresponding to the user data, but also a servo signal corresponding to the servo data. The signal-processing unit 17 includes a servo decoder that reproduces servo data from a servo signal.

The HDC 18 can function as an interface between the disk drive 10 and a host system 22 (e.g., personal computer or any one of various digital apparatuses). The HDC 18 performs the transfer of read data and write data between the disk medium 11 and the host system 22.

The CPU 19 is the main controller in the disk drive 10. It performs the writing of servo data in the present embodiment. To write the servo data, the CPU 19 controls the VCM driver 21, which in turn controls the actuator 14. The positioning of the head 12 is thereby carried out. The CPU 19 uses the servo data (drive-servo pattern, later described) recorded on the disk medium 11 to control the positioning of the head 12. The memory 20 includes a RAM and a ROM, in addition to a flash memory (EEPROM, i.e., a nonvolatile memory). It stores various data items and programs that control the CPU 19.

(Servo Pattern)

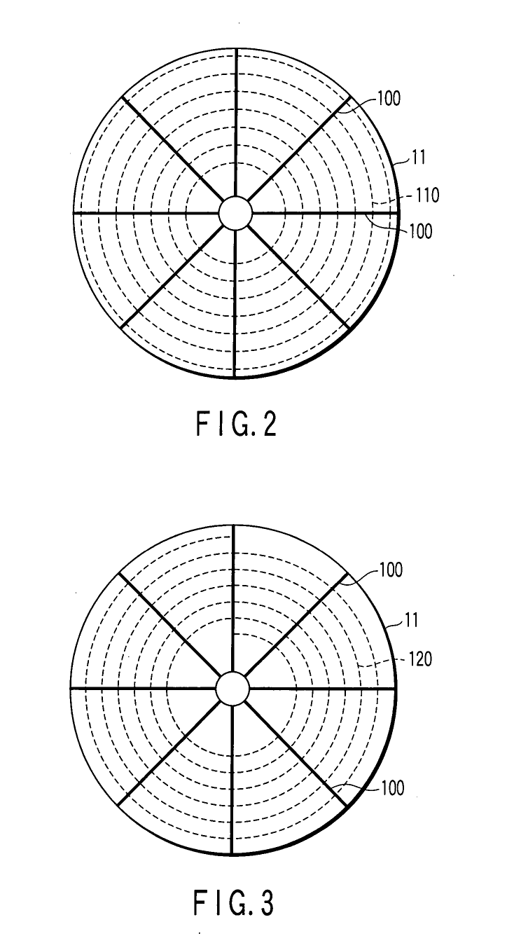

There are two types of servo patterns, one of which is recorded on any disk medium provided in disk drives. They are a concentric servo pattern and a spiral servo pattern. As shown in FIG. 2, a concentric servo pattern constitutes concentric servo tracks 110. In the concentric servo pattern, servo data items 100 are recorded on radial lines, and concentric servo tracks 110 connect the servo data items 100 at the borders of sectors. The word “sector” means a servo area in which a servo data item 100 is recorded.

As shown in FIG. 3, a spiral servo pattern constitutes a spiral servo track 120. In the spiral servo pattern, servo data items 100 are recorded on radial lines as in the concentric servo pattern, and the spiral servo tracks 120 connects the servo data items 100 at the borders of sectors.

The servo data (servo pattern), no matter whether it is concentric or spiral, includes address codes and a servo burst pattern (burst signals A, B, C and D). The address codes identify the tracks and sectors, respectively. The servo burst pattern is used to detect head-positioning errors in each track.

(Servo-Writing Process)

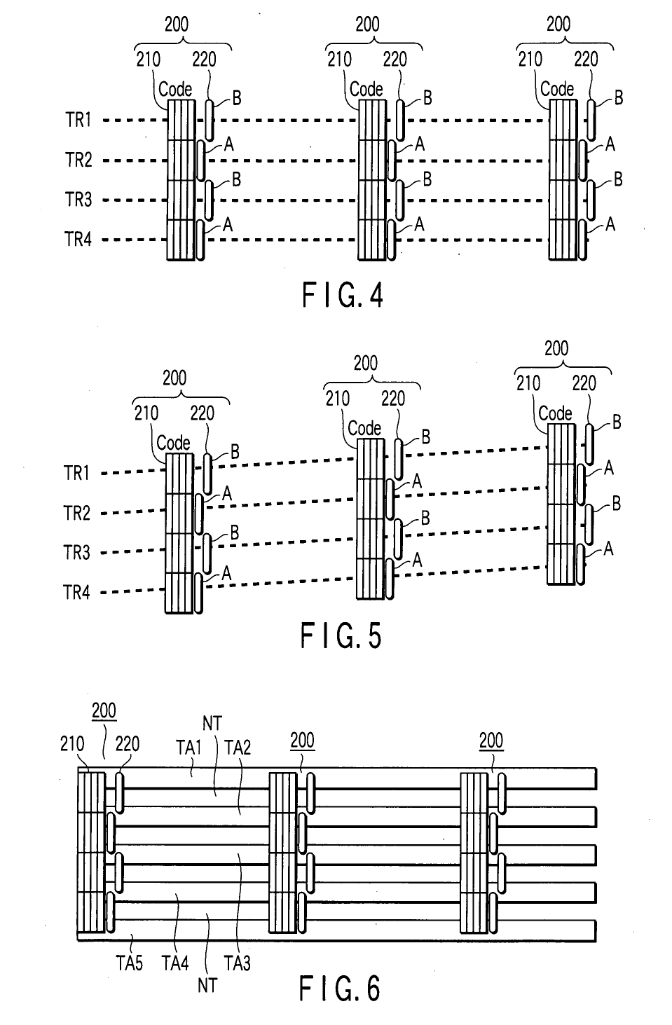

The servo-writing process according to the present embodiment will be explained, with reference to FIGS. 4 to 9, FIGS. 10A and 10B and FIGS. 11A to 11F.

The servo writing method according to this embodiment consists of two processes. In the first process, a base-servo pattern 200 is recorded on the disk medium 11. In the second process, a drive-servo pattern 300 is recorded on the disk medium 11 by using the base-servo pattern 200. The drive-servo pattern 300 is the servo pattern (servo data) that is used to control the position of the head 12 after the disk drive 10 has been shipped as a product.

FIGS. 4 and 5 are diagrams explaining the first process of recording the base-servo pattern 200 on the disk medium 11.

In the first process, the base-servo pattern 200 is written on the disk medium 11 incorporated in the disk drive 10 during the manufacture of the disk drive 10, by using a servo-track writer (STW) dedicated to the servo writing. The STW may not be used in this process. If this is the case, the CPU 19 of the disk drive 10 performs self-servo writing (SSW), thereby writing the base-servo pattern 200 on the disk medium 11.

In the first process, the base-servo patterns 200, i.e., concentric servo patterns, are written on, for example, four servo tracks (TR1 to TR4) as shown in FIG. 4. The base-servo patterns 200 thus written include address codes 210 and servo-burst patterns 220 (burst signals A and B) each.

The address code 210 contains a cylinder code (track address) and a sector code. The cylinder code identifies one track. The sector code identifies one sector. The servo-burst pattern 220 (burst signals A and B) is a signal for detecting a head-positioning error in the track (i.e., error of positioning the head with respect to the centerline of the track).

In the first process, the STW moves the head 12 in units of one-track pitches (1/1-track pitches), making the write head 12W write the base-servo patterns 200. That is, the STW moves and stops the head 12 four times as shown in FIG. 4, whereby the write head 12W writes base-servo patterns 200 for four servo tracks (TR1 to TR4), and at the same time writes the address codes 210 and servo-burst patterns 220 (burst signals A and B).

In the ordinary method of writing a concentric servo pattern, the head is moved in units of half-track pitches (1/2-track pitches), making the head to write a servo pattern. Hence, the head must be repeatedly moved and stopped eight times in order to write a servo pattern for four servo tracks. Thus, the servo-writing method performed in the first process of this embodiment can write a servo pattern, within about half the time required in the ordinary servo-writing method.

FIG. 5 explains how the base-servo patterns 200, i.e., a spiral servo pattern, are written on, for example, four servo tracks (TR1 to TR4) on the disk medium 11. The base-servo patterns 200 thus written include address codes 210 and servo-burst patterns 220 (burst signals A and B) each.

In this case, the STW moves the head 12, in the first process, at a constant angular velocity, in units of one-track pitches (1/1-track pitches), making the head 12 write the base-servo patterns 200. That is, the STW moves the head 12 at the constant angular velocity, whereby the write head 12W writes base-servo patterns 200 for four servo tracks (TR1 to TR4), while the disk medium 11 is rotating four times.

In the ordinary method of writing a spiral servo pattern, the head is moved at a constant angular velocity, while the disk medium is being rotated eight times, to write a spiral servo pattern for four servo tracks. Hence, the head must be repeatedly moved and stopped eight times in order to write a servo pattern for four servo tracks. Hence, the servo-writing method performed in the first process of this embodiment can write a spiral servo pattern, within about half the time required in the ordinary servo-writing method.

As described above, the first process records the base-servo patters 200 of either a centric servo pattern or a spiral servo pattern, on the disk medium 11 in the present embodiment.

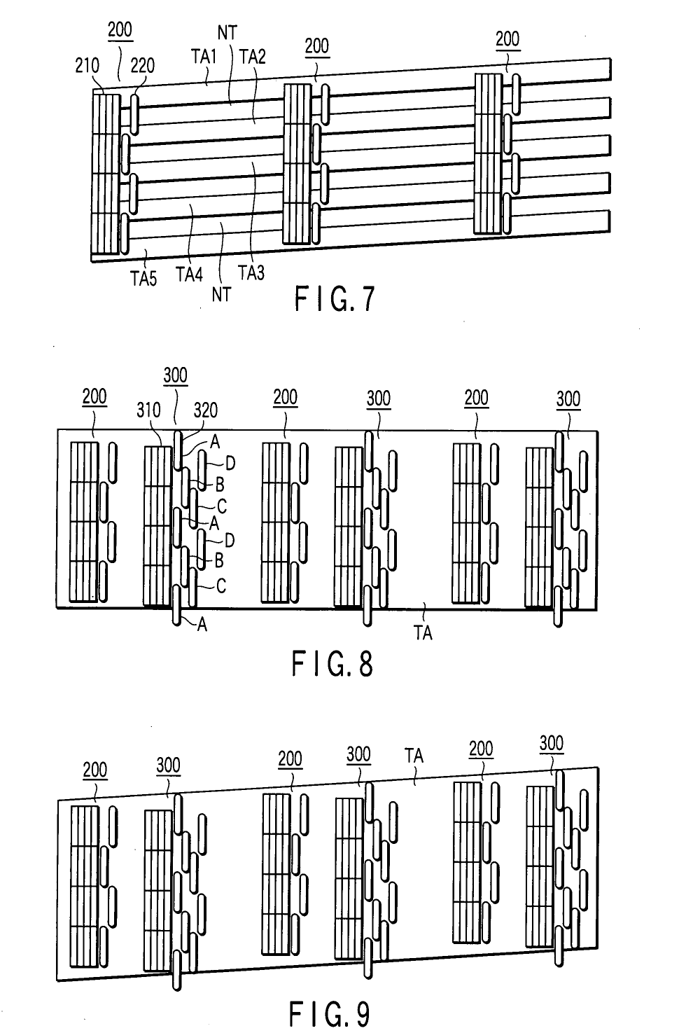

FIGS. 6 and 7 show areas TA1 to TA4 that can be tracked by using base-servo patterns 200 recorded on the disk medium 11 in the first process of the present embodiment. The areas TA1 to TA4 that can be tracked are track areas in which the head 12 can be positioned in accordance with the servo-burst patterns 220 contained in the base-servo patterns 200.

More specifically, FIG. 6 shows base-servo patterns 200, or concentric servo patterns, which are recorded on the disk medium 11, and FIG. 7 shows base-servo patterns 200 recorded on the disk medium 11 and constituting a spiral servo pattern.

In either case, areas NT, which cannot be tracked, exist between the areas TA1 to TA4 that can be tracked. Any area NT is an area from which no servo-burst signals can be detected. In other words, the head 12 cannot be positioned in the areas NT. Therefore, the base-servo patterns 200 cannot be used as servo pattern after the disk drive 10 has been shipped as a product.

The second process, i.e., servo-data writing process of writing a drive-servo pattern 300 by utilizing the base-servo patterns 200, will be explained with reference to FIGS. 8 and 9, FIGS. 10A and 10B and FIGS. 11A to 11F.

The second process according to this embodiment is a method of writing the drive-servo pattern 300 as the CPU 19 of the disk drive 10 performs the self-servo writing (SSW).

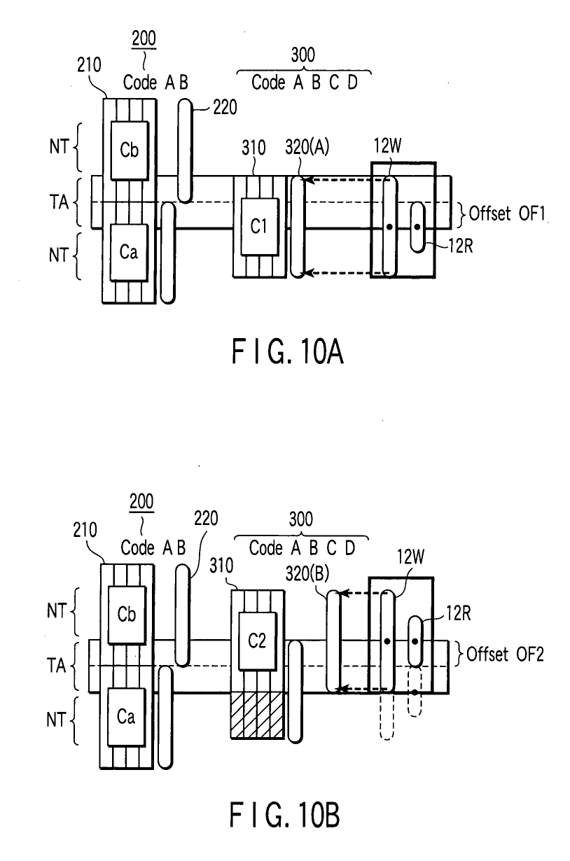

FIGS. 10A and 10B are diagrams that explain the principle of the second process.

In the present embodiment, the servo data is written by using the SSW function, in the following conditions. That is, the read width MRW of the read head 12R (i.e., width as measured in the radial direction of the track) is greater than half (½) the servo-track pitch of the base-servo patterns 200.

As FIG. 10A shows, two track areas TA that can be tracked exist between the cylinder codes Ca and Cb contained in the address code 210 of a base-servo pattern 200, with a border (broken line) that extends at right angles to the burst signals A and B.

The CPU 19 performs the SSW, making the read head 12R read the base-servo pattern 200. On the basis of the base-servo pattern 200, the CPU 19 controls the positioning of the write heat 12W. Then, the CPU 19 causes the write head 12W to write a drive-servo pattern 300, as product servo pattern, in a designated position on the disk medium 11.

More specifically, the CPU 19 moves the write head 12W in the track area TA, toward the cylinder code Ca by a ¼-servo track width (offset OF1) as shown in FIG. 10A and then makes the write head 12W write a cylinder code C1 and a servo-burst signal A. The cylinder code C1 is contained in the address code 310 of the drive-servo pattern 300. The servo-burst signal A is contained in the servo-burst pattern 320 of the drive-servo pattern 300.

Similarly, the CPU 19 moves the write head 12W in the track area TA, toward the cylinder code Cb by a ¼-servo track width (offset OF2) as shown in FIG. 10B and then makes the write head 12W write a cylinder code C2 and a servo-burst signal B. The cylinder code C2 is contained in the address code 310 of the drive-servo pattern 300. The servo-burst signal B is contained in the servo-burst pattern 320 of the drive-servo pattern 300.

Thus, in the second process, the CPU 19 of the disk drive 10 moves the write head 12W on a track, toward the cylinder codes Ca and Cb by setoff distances OF1 and OF2, respectively. While being so moved, the write head 12W writes the drive-servo pattern 300 at the designated position on the disk medium 11. In this case, a drive-servo pattern 300 containing different cylinder codes and different burst signals can be written in the same tracking area TA that has been set on the basis of the base-servo pattern 200.

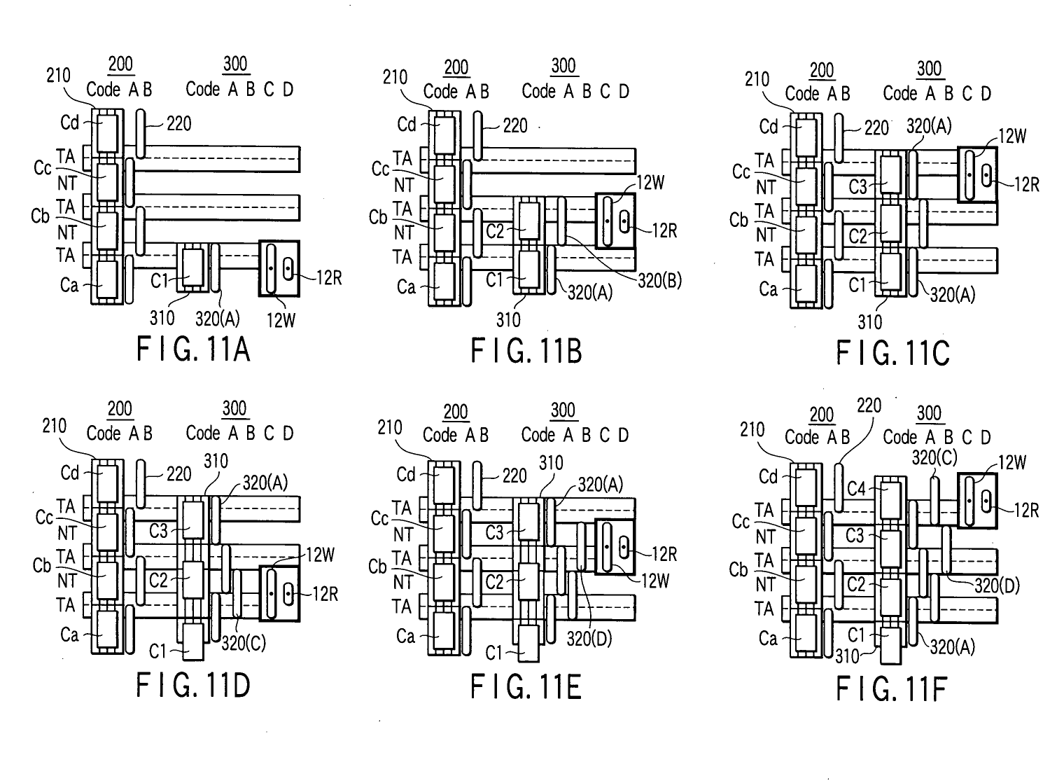

The sequence of the second process of writing drive-servo pattern 300 by utilizing the SSW function of the disk drive 10, as explained above, will be described in detail with reference to FIGS. 11A to 11F.

First, the CPU 19 moves the write head 12W toward the cylinder code Ca of the base-servo pattern 200, by a ¼-servo track width as shown in FIG. 11A, making the write head 12W write a cylinder code C1 and a servo-burst pattern 320 (burst signal A). The cylinder code C1 thus written is a cylinder code contained in the address code 310 of the drive-servo pattern 300.

The servo-burst pattern 320 is the burst signal A that is contained in the servo-burst pattern 320 of the drive-servo pattern 300. Hereinafter, the cylinder codes (C2 to C4) and servo-burst patterns 320 (burst signals to D), which are contained in the address code 310 of the drive-servo pattern 300, are written in the same manner as the cylinder code C1 and burst signal A.

More precisely, the CPU 19 moves the write head 12W toward the cylinder code Cb by a ¼-servo track width as shown in FIG. 11B, making the write head 12W write a cylinder code C2 and a servo-burst pattern 320 (burst signal B).

Then, the CPU 19 moves the write head 12W toward the cylinder code Cc by a ¼-servo track width as shown in FIG. 11C, making the write head 12W write a cylinder code C3 and a servo-burst pattern 320 (burst signal A).

Next, the burst signals C and D of the servo-burst pattern 320 are written. That is, as shown in FIG. 1D, the CPU 19 moves the write head 12W toward the cylinder code Cb by a ¼-servo track width, making the write head 12W write a cylinder code C2 and a servo-burst pattern 320 (burst signal C).

Further, as shown in FIG. 1E, the CPU 19 moves the write head 12W toward the cylinder code Cc by a ¼-servo track width, making the write head 12W write a cylinder code C3 and a servo-burst pattern 320 (burst signal D)

Still further, as shown in FIG. 11F, the CPU 19 moves the write head 12W toward the cylinder code Cd by a ¼-servo track width, making the write head 12W write a cylinder code C4 and a servo-burst pattern 320 (burst signal C).

As the second process proceeds in the sequence described above, the drive-servo pattern 300 is written in the servo sector 100 provided on the disk-shaped medium 11, by utilizing the SSW function incorporated in the disk drive 10. That is, the positioning (tracking) of the write head 12 can be controlled by using the base-servo pattern 200 of 1/1-servo-track pitch, which has been recorded on the disk-shaped medium 11 in the first process. Thus controlled in position, the write head 12W can write, for example, the drive-servo pattern 300 for driving the head 12 at a 1/2-servo track pitch.

As shown in FIGS. 8 and 9, the drive-servo pattern 300 has no areas (i.e., areas NT) from which servo-burst signals cannot be detected. Hence, the head 12 can track the entire surface of the disk medium. Once the disk drive 10 has been shipped as a product, the CPU 19 can use the drive-servo pattern 300, controlling the position of the head 12, thereby to make the head 12 read or write the user data from and on the disk medium 11.

The base-servo pattern 200 is no longer necessary in the disk drive 10 shipped. Therefore, it may be erased from the disk medium 11. To erase the base-servo pattern 200, a process (i.e., third process) of erasing the pattern 200 is performed in the manufacture of the disk drive 10. A data item that identifies the pattern 200 may be recorded on the disk medium 11 during the manufacture of the disk drive 10, thus distinguishing the base-servo pattern 200 from the drive-servo pattern 300. In this case, the base-servo pattern 200 is erased by overwriting.

As described above, the present embodiment is a servo-writing method in which the base-servo pattern 200 and the drive-servo pattern 300 are written in the first process and the second process, respectively.

In the first process, the base-servo pattern 200 of either the concentric servo pattern or the spiral servo pattern is recorded at the one-track pitch (1/1 servo track pitch). Hence, as indicated above, the servo-writing method performed in the first process can write a concentric or spiral servo pattern, within about half the time required in the ordinary servo-writing method in which servo patterns are written at the half-track pitch (1/2-track pitch).

Moreover, the drive-servo pattern 300 is written at the 1/2-track pitch in the second process. If the drive-servo pattern 300 is a spiral servo pattern, the servo-data writing time can be shortened. That is, the spiral servo pattern can be continuously written, for example, from the innermost track to the outermost track, without stopping the head 12 during the pattern-writing process. Since the head 12 is never stopped during this process, the servo pattern can be written on the entire surface of the disk medium 11, within a relatively short time.

In the disk drive 10 according to this embodiment, the drive-servo pattern 300 for the spiral servo pattern recorded on the disk medium 11 may be used as a spiral data track in which the user data may be recorded. Alternatively, in the disk drive 10 according to this embodiment, the drive-servo pattern 300 for the spiral servo pattern recorded on the disk medium 11 may be used as concentric data tracks in which the user data may be recorded.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of writing servo data in a disk drive which has a disk medium and a servo-writing function of recording servo data on the disk medium, the method comprising:
a first process of recording a base-servo pattern containing address codes and servo-burst patterns, on the disk medium at a one-track pitch; and
a second process of controlling the positioning of a head by using the base-servo pattern in the disk drive and causing the head to record a drive-servo pattern on the disk medium in addition to the base-servo pattern, the drive-servo pattern constituting a spiral servo pattern track.

2. The method according to claim 1, wherein the positioning of the head is controlled in units of 1/2-track pitches in the second process, thereby recording the drive-servo pattern.

3. The method according to claim 1, wherein the base-servo pattern is recorded in the first process on the disk medium incorporated in the disk drive, by using the servo-writing function of the disk drive.

4. The method according to claim 1, wherein the base-servo pattern is recorded on the disk medium in the first process, by using a dedicated servo-writing apparatus.

5. The method according to claim 1, wherein the base-servo pattern is a servo pattern constituting concentric servo tracks.

6. The method according to claim 1, wherein the base-servo pattern is a servo pattern constituting a spiral servo track.

7. The method according to claim 1, further comprising a third process of erasing the base-servo pattern from the disk medium after recording the drive-servo pattern on the disk medium in the second process.

8. The method according to claim 1, wherein a two-phase burst signal composed of servo burst signals A and B is recorded as the base-servo pattern, in addition to the address codes.

9. A disk drive comprising:
a disk medium on which a base-servo pattern has been recorded;
a head which is configured to write servo data or user data on the disk medium and to read the servo data or the user data from the disk medium;
a control unit which is configured to control the positioning of the head by using the base-servo pattern and which performs self-servo writing to make the head record, on the disk medium, a drive-servo pattern constituting a spiral servo track, in addition to the base-servo pattern; and
an actuator mechanism which holds the head and which is configured to moves the head to a designated position on the disk medium, when controlled by the control unit.

10. A disk drive comprising:
a disk medium on which a base-servo pattern has been recorded;
a head which is configured to write servo data or user data on the disk-shaped medium and to read the servo data or the user data from the disk medium;
an actuator mechanism which holds the head and which is configured to moves the head to a designated position on the disk medium; and
a control unit which is configured to control the actuator mechanism and which performs self-servo writing by using the base-servo pattern, thereby recording, on the disk medium, a drive-servo pattern for constituting a spiral servo track, and then uses the drive-servo pattern, thereby constituting a spiral servo track for recording user data on the disk medium.
